(19) United States
(12) Patent Application Publication
(10) Pub. No.: US 2004/0164939 A1
(43) Pub. Date: Aug. 26, 2004

(54) Display device comprising a plurality of leds

(76) Inventors: Mark Thomas Johnson, Eindhoven (NL); Johannes Nicolaas Huiberts, Eindhoven (NL); Andrea Giraldo, Eindhoven (NL)

Correspondence Address: Corporate Patent Counsel, Philips Electronics North America Corporation, PO Box 3001, Briarcliff Manor, NY, 10510, US

(21) Appl. No.: 10/477,489

(22) PCT Filed: May 15, 2002
(86) PCT No.: PCT/IB02/01701

(30) Foreign Application Priority Data
May 15, 2001 (EP) 01201811.5

(51) Int. Cl. G09G 3/32

(52) U.S. Cl. 345/82

(57) ABSTRACT

The invention relates to a display device comprising a plurality of light-emitting diodes (LEDs), which comprise at least one layer of an electroluminescent (EL) material sandwiched between electrodes, and driving means for driving the diodes. The device further comprises means for applying a reverse voltage to one or more individual diodes or groups of diodes and means for measuring the leakage current resulting from this reverse voltage. The invention also relates to a method of manufacturing such a display device and to an electronic device, such as a mobile telephone or an organiser, comprising such a display device.

The invention relates to a display device comprising a plurality of light-emitting diodes (LEDs), which comprise at least one layer of an electroluminescent (EL) material sandwiched between electrodes, and driving means for driving the diodes. The invention also relates to a method of manufacturing such a display device and to an electronic device, such as a mobile telephone or an organiser, comprising such a display device.

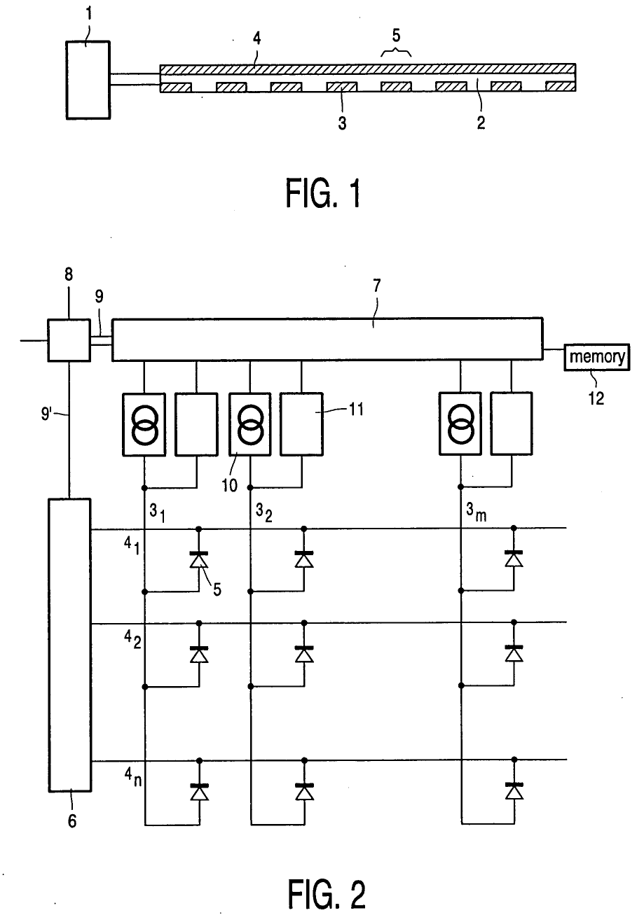

Display devices of this type are known from, for instance, Japanese Patent Application no. 09150106 (publication no. 10321367). This document describes a testing device for evaluating EL displays comprising data electrodes (numeral 24 in FIG. 1), scanning electrodes (23) and an organic EL layer sandwiched between them. The electrodes are arranged in rows and columns, thus forming a matrix.

The displays are tested by applying an inspection voltage to the electrodes and ‘judging the quality from a value of an electric current flowing between the voltage-generating means and the organic EL display.’

WO 01/22504 discusses the risk of dust adhesion on an organic EL element. Since the organic EL functional layer has a very small thickness of a submicron order, a short circuit due to dust or other particles may occur between the electrodes. Although the occurrence of short circuits can be reduced through cleanliness, they will probably always be a factor in the production and reliability of EL displays. WO 01/22504 suggests subjecting the EL layer to a reverse bias, measuring the leakage current and, depending on the value thus measured, accepting or rejecting the device comprising the said layer.

It is an object of the present invention to improve the yield of the production of EL display devices and/or to reduce the risk of a short circuit occurring once the display device is in use. After all, a short circuit in a single diode of e.g. a matrix display may lead to the fall-out of a full row and column, which in turn renders the display and, hence, the electronic device of which it is a part, practically useless.

To meet this object, the display device of the invention is characterized in that the device comprises means for applying a reverse voltage to one or more individual diodes or groups of diodes and means for measuring the leakage current resulting from this reverse voltage.

The leakage current is indicative of the risk that a short circuit will occur in a particular diode or group of diodes. The display device according to the invention comprises a capability for locating diodes or groups of diodes wherein the leakage current or a value derived therefrom exceeds a predetermined threshold value (hereinafter also referred to as ‘weak’ diodes) and thus allows a timely and tailored reduction of the load of such diodes. This can be done by e.g. decreasing the frequency or the current with which they are driven.

In order to reduce the number of measurements that must be carried out to localise a weak diode, it is preferred that said capability is arranged to measure the leakage current of groups of diodes and, if the leakage current or a value derived therefrom in a particular group exceeds a predetermined threshold value, subsequently of subsections of this group.

It is further preferred that the display device comprises a memory for storing a parameter concerning one or more tested diodes or groups of diodes, such as the measured leakage current, leakage current instability, or a value derived from one or both of these quantities. Thus, the localising of weak diodes need not be repeated whenever the display is driven.

The method according to the invention is characterized in that individual diodes or groups of diodes are subjected to a reverse voltage, and in that the leakage current, leakage current instability or a value derived from one or both of these quantities resulting from this reverse voltage is measured and compared with a predetermined threshold value. If a weak diode e.g. appears to be at a location where it is rarely driven, it may still be acceptable to use the display device, optionally in a second-grade device or application, and need not be rejected.

It is preferred that the driving means are subsequently programmed to reduce the load on diodes or groups of diodes, of which said parameter exceeds said threshold value. It may be sufficient, for instance, to simply relocate frequently used symbols, such as an icon representing the state of the battery of a mobile telephone.

The invention will be further explained by means of a detailed description of several embodiments.

FIG. 1 schematically shows a cross-section of part of an electroluminescent display device according to the present invention.

FIG. 2 shows an equivalent circuit diagram of a display device according to the present invention.

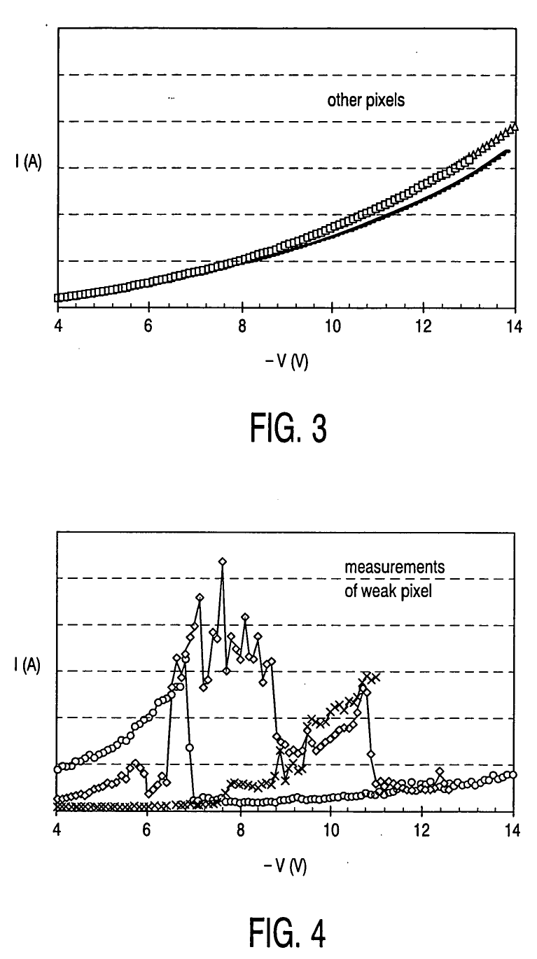

FIGS. 3 and 4 show the results of measuring a leakage current in normal diodes and a weak diode, respectively.

FIG. 1 shows part of an electroluminescent display device comprising driving means 1 and a matrix of light-emitting diodes (LEDs; in this context also referred to as pixels) comprising an active or emissive layer 2 of, for instance, a conjugated polymer like PPV (poly(p-phenylene vinylene)) or a PPV-derivative, sandwiched between two patterned electrode layers of an electroconductive material, i.e. column or data electrodes 3 and row or selection electrodes 4. The column electrodes 3 are usually made of a transparent conductive oxide (TCO), such as indium oxide or indium tin oxide (ITO), whereas the row electrodes 4 are usually made of aluminium or a material with a low work function like calcium or magnesium.

During operation, the column electrodes 3 are driven in such a way that they are at a sufficiently high positive voltage relative to the row electrodes 4 to inject holes into the active layer 2. The row electrodes 4 serve (relative to the electrodes 3) as negative electrodes for the injection of electrons in the active layer 2. The material for the row electrodes 4 may be, for instance, aluminium or a material with a low work function like calcium or magnesium.

For further details on the above-mentioned electrodes, suitable conjugated polymers for use in the active layer, thickness of these layers, and substrates for the LED structure, reference may be made to International Patent Application PCT/IB96/00414 (Publ. No. WO 96/36959).

FIG. 2 schematically shows an electrical equivalent circuit diagram of a part of a matrix of LEDs 5 having N rows and M columns. This diagram shows that the driving means 1 include a row selection circuit 6 (for example, a multiplex circuit), a data register 7, and a control unit 8. Information presented from the exterior, for example, an image signal, is processed in the control unit 8 and fed to the row selection circuit 6 and the data register 7 via control lines 9, 9′.

In a first embodiment according to the present invention, the display device further comprises a current source 10 for each column and either a current measurement capability or, preferably, a switch 11 for connecting the column electrodes 3 to a central current measurement capability integrated in e.g. the data register 7 or the control unit 8. Instead of using switches 11, it is of course also possible to provide a conductive path or lead and M switches for connecting the column electrodes 3₁ . . . 3_{M} to the current measurement capability.

The matrix can be driven in several ways, for instance by addressing each row electrode 4₁ . . . 4_{N} one at a time through a reduction of the row voltage from a non-selection voltage Vₙₒₙₛₑₗ to a selection voltage Vₛₑₗ. A current is then applied to each LED sequentially for a period of tₚ (tₚ is the line time divided by the number of columns, M) or, more commonly, simultaneously for a period close to tₗᵢₙₑ (full line time).

However, according to the invention, the leakage current is first probed at each column by means of a reverse voltage e.g. a brief pulse of 1 msec of a negative voltage of −8V, a succession of pulses, e.g. four pulses of −4V, −6V, −8V, and −10V, or a negative voltage ramp. If the measured leakage current exceeds a certain level or exhibits a substantial, irregular variation, a switch in the respective current source is opened and a driving current to that particular diode is avoided.

An advantage of this embodiment is that a weak or deteriorating diode is spotted at an early instant. It is especially suitable for driving segmented displays, where the number of display segments is relatively small, and for displays where reliability is of vital importance.

In general, it is preferred that the display is provided with a line or frame memory 12 for storing a parameter, such as the measured leakage current or leakage current instability of the diodes 5 in a line or the entire display, respectively. The load on any weak diode can be reduced in accordance with the stored information. When a frame memory is used, measurements can be carried out less frequently, for instance once a day or hour or only when the display is turned on.

Localising a weak diode can be made more efficient by measuring the reverse bias current in subsections of the display. For instance, by measuring the reverse bias current of the two halves of a display, followed by measuring the two halves of the half that apparently comprises a weak diode, and so forth, one can identify the weak diode very rapidly with a limited number of measurements.

FIGS. 3 and 4 show the results of measurements for localising a weak diode in a 96-column, 64-row PLED matrix display. The display was divided into sixteen 24×16 blocks and the reverse leakage current was measured. In fifteen blocks, a smoothly increasing current was measured as the voltage became more negative (FIG. 3), whilst in one block, a very unstable (“noisy”) current was measured between −3V and −10V (round marker in FIG. 4). This block was subdivided into sixteen 6×4 blocks, resulting in a smooth current in fifteen blocks (similar to FIG. 3) and a noisy current in one block (cross marker in FIG. 4). The leakage current in the individual diodes in the latter block was measured and the exact location of the weak diode (diamond marker in FIG. 4) was obtained.

Once the weak diode has been detected, there are several approaches to reducing the risk of a short circuit actually occurring. The use of a section of the display where the weak diode was located or the use of just the weak diode itself could be minimized or even be avoided. For instance, if the display spends most of its time in a standby mode, with only a small part of the display being active, this active part should preferably avoid the weak diode, i.e. it should be relocated. Alternatively, the weak diode could be driven in a ‘softer’ manner, e.g. at an artificially reduced brightness, thus extending the life of the display with only a minimal reduction in perceived display quality. In some cases, it is possible to repair a weak diode, e.g. by passing a short pulse with a predefined (high) intensity to burn away the cause without inducing a short circuit. All of these capabilities can be added to the driver electronics. Moreover, a feedback mechanism can be incorporated to measure the reverse leakage current after a repair procedure has been undertaken and, if necessary, adjust, e.g. by increasing the voltage, and repeat the repair procedure. Such a procedure can be repeated until either the repair is successful or a predefined limit is reached beyond which further attempts are no longer useful.

If the weak diode is localised during the manufacture of the display by means of a separate apparatus, it can be employed to increase the yield of this manufacture. The displays could be given a grade or class, e.g.: class 1 for displays that do not comprise weak diodes (at least not initially), class 2 for displays with a single weak diode or very few weak diodes which could still be used in many applications (particularly those with a standby mode) by a modification e.g. through re-programming or pre-programming of the driver(s), and class 3 for displays with either too many weak spots or actual short circuits. The latter class should still be rejected.

The invention is not limited to the above-described embodiments which can be varied in a number of ways within the scope of the claims. For instance, noise detection can be carried out in numerous ways, e.g. by counting high current peaks or by measuring current fluctuations and, optionally, by calculating a normalised noise level as disclosed in WO01/22504. The invention can also be implemented in passive, active, and segmented displays.

1. A display device comprising a plurality of light-emitting diodes (5), which comprise at least one layer (2) of an electroluminescent material sandwiched between electrodes (3,4), and driving means (1) for driving the diodes (5), characterized in that the device comprises means (6) for applying a reverse voltage to one or more individual diodes (5) or groups of diodes (5) and means (11) for measuring the leakage current resulting from this reverse voltage.

2. A display device as claimed in claim 1, wherein said means (6,11) are arranged to measure the leakage current of groups of diodes (5) and, if the leakage current or a value derived therefrom in a particular group exceeds a predetermined threshold value, subsequently of subsections of said group.

3. A display device as claimed in claim 1 or 2, which comprises a memory unit (12) for storing a parameter concerning one or more tested diodes (5) or groups of diodes (5), such as the measured leakage current, leakage current instability, or a value derived from one or both of these quantities.

4. A display device as claimed in any one of the preceding claims, wherein the driving means (1) are arranged to reduce the load on diodes (5) or groups of diodes (5), of which the leakage current or said parameter, respectively, exceeds a predetermined threshold value.

5. A display device as claimed in claim 4, wherein the driving means (1) are arranged to decrease the current or the duration with which such diodes (5) or groups of diodes (5) are driven.

6. A display device as claimed in claim 4, wherein the driving means (1) are arranged to substantially avoid the driving of such diodes (5) or group of diodes (5).

7. A display device as claimed in any one of claims 1 to 3, wherein the means (6) for applying a reverse voltage are arranged to generate a pulse of a relatively high reverse voltage.

8. A display device as claimed in claim 7, wherein said means (6) are arranged to subsequently measure the reverse leakage current and, if the leakage current or a value derived therefrom in a particular group still exceeds a predetermined threshold value, generate a further pulse, which has preferably been adjusted.

9. A display device as claimed in any one of the preceding claims, wherein the means (6) for applying a reverse voltage, the means (11) for measuring the leakage current resulting from this reverse voltage, and/or the memory unit (12) are integral parts of the driving means (1).

10. A method of manufacturing a display device comprising a plurality of light-emitting diodes (5), which comprise at least one layer (2) of an electroluminescent material sandwiched between electrodes (3,4), and driving means (1) for driving the diodes (5), characterized in that individuals diodes (5) or groups of diodes (5) are subjected to a reverse voltage, and in that the leakage current, leakage current instability or a value derived from one or both of these quantities resulting from this reverse voltage is measured and compared with a predetermined threshold value.

11. A method as claimed in claim 10, wherein the driving means (1) are subsequently programmed to reduce the load on diodes (5), or groups of diodes (5), of which said parameter exceeds said threshold value.

12. A method as claimed in claim 11, wherein diodes (5) or groups of diodes (5), of which said parameter exceeds a predetermined threshold value, are subjected to a pulse of a relatively high reverse voltage.

13. An electronic device, such as a mobile telephone or an organiser, comprising a display device as claimed in any one of claims 1 to 9 or a display device obtainable by means of the method as claimed in any one of claims 10 to 12.
